(19) United States
(12) Patent Application Publication
(10) Pub. No.: US 2026/0192534 A1
(43) Pub. Date: Jul. 9, 2026

(54) HIGH SPEED LASER INDUCED REFRACTIVE INDEX CHANGE WRITING IN OPTICAL MATERIALS

(71) Applicant: University of Rochester, Rochester, NY (US)

(72) Inventors: Wayne H. Knox, Rochester, NY (US); Zachary Alexander Manning, Rochester, NY (US)

(21) Appl. No.: 19/499,777

(22) PCT Filed: Jul. 3, 2024
(86) PCT No.: PCT/US2024/036690

§ 371 Date: Jan. 6, 2026

Related U.S. Application Data
(60) Provisional application No. 63/525,459, filed on Jul. 7, 2023.

(51) Int. Cl. B29D 11/00

(52) U.S. Cl. CPC B29D 11/00461

(57) ABSTRACT

A method for writing a desired phase change pattern in an optical polymeric material includes generating at least one pulsed laser beam output from a pulsed laser source, were the pulsed laser beam output has a laser beam cross sectional area with at least one cross sectional linear dimension of at least 5 mm; exposing the optical polymeric material to the pulsed laser beam output simultaneously over at least a portion of the optical polymeric material having at least one linear dimension of at least 5 mm; and controlling an intensity of the simultaneous exposure of the pulsed laser beam output over the at least a portion of the optical polymeric material to obtain an energy profile within the optical polymeric material above a nonlinear absorption threshold of the optical material and below a breakdown threshold of the optical polymeric material, and to obtain a desired change in refractive index in the at least a portion of the optical polymeric material. The intensity of the simultaneous exposure of the pulsed laser beam output may be differentially modulating over the at least a portion of the optical polymeric material to obtain a modulated energy profile within the optical polymeric material including at least some energy profile portions above a nonlinear absorption threshold of the optical material and all of the energy profile below a breakdown threshold of the optical polymeric material at which significant light scattering or absorption degrades the intended performance of the optical polymeric material, and obtaining a desired modulated change in refractive index in the simultaneously exposed portion of the optical polymeric material.

### TECHNICAL FIELD

The application relates to using a pulsed laser to modify the refractive index of an optical medium, and particularly to high speed writing of refractive index changes into optical devices such as contact lenses for high volume manufacturing of custom contact lenses.

### BACKGROUND

Pulsed lasers operating within specified regimes specially adapted to target optical materials have been demonstrated to produce localized refractive index changes in the optical materials without otherwise damaging the materials in ways that would impair vision by creating unwanted optical scattering. In previous disclosed systems, the laser energy is typically tightly focused to concentrate the light into a diffraction-limited (micron scale) spot, which causes multi-photon absorption-induced refractive index changes. In order to form a quasi-continuous three-dimensional refractive index distribution inside an ophthalmic optical material such as a contact lens, the beam may be scanned inside the material while the laser fires repeatedly. If the laser repetition rate is high enough, then the written spots overlap significantly and continuous lines of refractive index change may be written. By modulating the laser scanning speed and/or the laser intensity while the laser is scanned over an area, complicated refractive index change patterns may be written that are precisely calibrated to produce desired refractive correction.

The employed energy regimes, while above the nonlinear absorption threshold, are typically maintained just below the breakdown thresholds of the optical materials at which significant light scattering or absorption degrades their intended optical performance. The considerations of these adapted energy regimes include pulse wavelength, pulse energy, pulse duration, the size and shape into which the pulses are focused into the optical material, and the temporal and physical spacing of the pulses.

Examples of refractive index writing systems include US Patent Application Publication No. 2013/0226162 entitled Method for Modifying the Refractive Index of Ocular Tissues, which discloses a laser system for changing the index of refraction of cornea tissue in a living eye for forming of modifying optical elements including Bragg gratings, microlens arrays, zone plates, Fresnel lenses, and combinations thereof. Here wavelengths are preferably between 400 nm and 900 nm, pulse energies are preferably between 0.01 nJ and 10 nJ, pulse duration is preferably between 10 fs and 100 fs, the repetition rate is preferably between 10 MHz and 500 MHz, the numerical aperture is preferably about 0.70 producing a focused spot diameter and resulting scanned line width between approximately 0.6 μm to 1.5 μm and a line depth between 0.4 μm to 8 μm, and the scan rate is between approximately 0.1 μm/s to 10 mm/s. US Patent Application Publication No. 2013/0268072 entitled Optical Hydrogel Material with Photosensitizer and Method for Modifying the Refractive Index discloses a method for modifying the refractive index of an optical, hydrogel polymeric material prepared with a photosensitizer particularly for the purposes of enhancing the efficiency of nonlinear absorption and increasing the scan rate at which refractive structure can be formed. Wavelengths are preferably between 650 nm to 950 nm, pulse energies are preferably between 0.05 nJ to 10 nJ, pulse duration is preferably between 4 fs and 100 fs, the repetition rate includes by way of example both 80 MHz and 93 MHz, the numerical aperture is preferably about 0.70 producing a focused spot diameter and resulting scanned line width between approximately 0.6 μm to 1.5 μm and a line depth between 1 μm to 4 μm, and the scan rate is between approximately 0.1 μm/s to 4 mm/s. US Patent Application Publication No. 2015/0126979 entitled Method for Modifying the Refractive Index of an Optical Material discloses the writing of selected regions of optical hydrogel materials prepared with a hydrophilic monomer following implantation of the prepared material into the eye of the patient. Wavelengths are preferably between 600 nm to 900 nm, pulse energies are preferably between 0.01 nJ to 50 nJ, pulse duration is preferably between 4 fs and 100 fs, the repetition rate includes by way of example 93 MHz, the numerical aperture is preferably about 0.70 producing a focused spot diameter and resulting scanned line width between approximately 0.2 μm to 3 μm and a line depth between 0.4 um to 8 um, and a demonstrated scan rate is approximately 0.4 μm/s. US Patent Application Publication No. 2015/0378065 entitled Method for Modifying the Refractive Index of an Optical Material and resulting Optical Vision Component, which discloses the writing of gradient refractive index (GRIN) layers in optical polymeric materials. Wavelengths are preferably between 750 nm to 1100 nm, pulse energies are preferably between 0.01 nJ to 20 nJ, pulse duration is preferably between 10 fs and 500 fs, the repetition rate is preferably between 10 MHz and 300 MHz, the numerical aperture is preferably about 0.70 producing a focused spot diameter and resulting scanned line width between approximately 0.6 μm to 3 μm and a line depth between 0.4 μm to 8 μm, and the scan rate is between approximately 0.1 mm/s to 10 mm/s. These referenced patent applications are hereby incorporated by reference.

In all such cases, use of a scanned, relatively small (e.g., 1-2 micrometer diameter) focused laser spot enables writing only in a thin region, and giving limited phase shift. Furthermore, constraints relating to the need to deliver highly overlapping concentrated pulse energies of a laser beam in a form that achieves the desired refractive index changes in the optical materials without exceeding the damage threshold at which the desired optical performance is degraded have limited the speed and efficiency with which refractive index structures can be written into the optical materials. Ultimately such focused spot scanning systems are limited in writing speed by laser scanner parameters.

It is of interest in the present disclosure to reduce or eliminate scanner limitations, and to enable high volume manufacturing applications of laser induced refractive index change writing in optical materials by increasing effective writing speed.

### SUMMARY

Embodiments for writing refractive index changes in optical polymeric material devices as envisioned by the inventors incorporate use of relatively high laser pulse energies while spreading out the laser exposure over larger simultaneously exposed optical material volume in order to realize laser induced refractive index changes over large areas with only single pulse exposures or relatively few overlapping pulse exposures. Various disclosed embodiments may expand opportunities for improving the speed and efficiency with which refractive index structures can be written into optical materials. The opportunities include achieving greater refractive index changes in a laser exposed region, improving continuity or control over the refractive index changes over exposed regions, expanding the area or thickness over which the refractive index changes are made in the laser exposed regions with single or fewer pulses, and writing refractive index features in a series of optical materials at high volumes. A relatively large area of an optical material can be simultaneously exposed to a pulse of the laser beam to spread the pulse energy throughout a greater volume for increasing the size of a volume of the optical material to refractive index change. The laser pulses may be simultaneously differentially linearly (i.e., one dimensionally) or areally (i.e., two dimensionally) modulated across a relatively large exposed region to achieve desired refractive index changes over larger volumes while avoiding the damage thresholds at which the materials undergo undesired changes that would degrade their optical performance. The refractive index changes written into the optical material include relatively increasing or decreasing the refractive index of the laser exposed regions of the optical material according to the local reaction of the optical material to the pulses delivered.

### BRIEF DESCRIPTION OF THE DRAWING FIGURES

FIG. 1 is a simplified schematic illustration of a non-scanned refractive index writing system for custom contact lenses.

FIG. 2 is an illustration showing individual single shot refractive index spots written at 8.3 MHz.

FIG. 3 is an illustration of an unfocused femtosecond high energy laser beam incident on a curved contact lens.

FIG. 4 is an illustration of a high speed delivery and position system transport mechanism for dehydrated contact lenses still in their manufacturing molds.

FIG. 5 is a schematic of a writing system using a cylindrical lens focus configuration.

FIGS. 6A-6C show (6A) a white light photo of the diffraction grating in transmission, (6B) the 1 cm×1 cm area written, and (6C) scatterometer measurements of the diffraction pattern.

FIG. 7 is an illustration of an assembly-line system for processing high speed writing of customized contact lenses.

FIG. 8 is an illustration of a focusing lens with a Petzval curvature matched to a contact lens curvature for writing a series of 1D line scans in a curved element.

FIGS. 9A-9B illustrate results from writing a cylinder focused line exposures in a curved contact lens.

### DETAILED DESCRIPTION

It is an object of this disclosure to present new methods and systems for writing refractive index changes in optical polymeric material elements, which may be used for refractive correctors, such as optical polymeric contact lenses. In particular, the disclosed methods may be most useful when applied to the problem of high speed, or high-volume custom contact lens fabrication, where it may be desirable to write relatively high volumes of customized lenses per unit of time, e.g. as many as ten or more laser written refractive index modified lenses per second. Instead of using a laser beam that is tightly focused to a relatively small focal spot and scanned throughout the sample volume, simultaneous laser exposure of a polymeric material element over a relatively large area having at least one linear dimension of at least 1 mm, and in particular embodiments at least 5 mm, preferably of at least 6 mm, and more preferably of at least 6.5 mm, with each laser pulse is described. Simultaneous exposure over such dimensions is desired, e.g., in order to enable rapid writing over a relatively large portion and even over an entire optically active zone of a contact lens. In various embodiments, e.g., a pulse laser output exposure may be simultaneously made over a pulsed laser output focal line having a length of at least 1 mm (or at least 5 mm, or at least 6 mm, or at least 6.5 mm) with subsequent laser pulses being scanned across a width of desired area of an optical polymeric material element to be written with a refractive index pattern, or may be simultaneously made over a cross-sectional area having at least two perpendicular linear dimensions of at least 1 mm (or at least 5 mm, or at least 6 mm, or at least 6.5 mm) each, so as to enable writing desired refractive index pattern over a full desired area of an optical polymeric material element without requiring any scanning across the full desired area.

In various embodiments, the incident pulsed laser beam may be collimated, so that no means of focusing is needed. When the pulsed laser beam is of sufficient power and large enough in cross-sectional area to write the entire desired pattern, then no scanning system may be needed. Instead, a cross-sectional beam modulator may be employed to cross-sectionally modulate the intensity of the pulsed laser beam output simultaneously over a beam cross-sectional area to obtain a modulated energy profile within an optical polymeric material. In such embodiments, the modulated energy profile may be controlled to include at least some energy profile portions above a nonlinear absorption threshold of the optical material and all of the energy profile below a breakdown threshold of the optical polymeric material at which significant light scattering or absorption degrades the intended performance of the optical polymeric material in order to obtain a desired modulated change in refractive index in the simultaneously exposed portion of the optical polymeric material.

In particular embodiments, a sufficiently highly powered laser may be used such that a desired pattern may be written with a single laser pulse, or with only a few (e.g., less than 100, more preferably less than 10, and most preferably less than 5) overlapping laser pulses, which may be substantially less overlapping pulses than typically employed when writing refractive index changes with tightly focused small focal spots.

The laser beam excitation wavelength is generally used primarily in the transparency region of an optical material to be written in, such that non-linear multi-photon absorption is relied upon for generating a desired refractive index change in the volume of an optical polymeric materials, as opposed linear absorption which primarily occurs at the material surface. In such regard, preferred laser wavelengths may be, e.g., in the visible or near IR spectral regions, for which the optical polymeric material is substantially transparent. While substantially transparent to the laser wavelength, the polymeric material may include a photosensitizer dopant such as described, e.g., in US Patent Application Publication No. 2013/0268072, such as UV absorbers, particularly for the purposes of enhancing the efficiency of nonlinear multiphoton absorption.

### Non-Scanned Two-Dimensional Exposure Embodiment

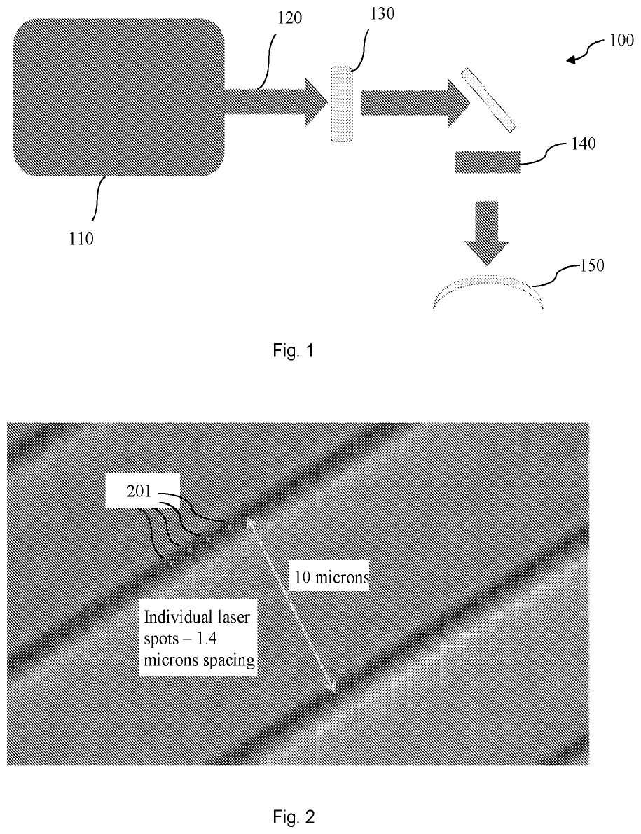

A simplified writing system that may be employed in one embodiment of the disclosure requiring no scanning system, e.g., is shown in FIG. 1. A laser system 100 employing a sufficiently powerful pulsed laser source 110 for writing a refractive index pattern simultaneously over a relatively large area generates laser pulses 120 within a sufficient range of pulsed laser parameters. Pulse repetition rate, e.g., in various embodiments could be single-shot laser pulses up to 100 Hz, up to 1 KHz, or up to 10 KHz. The wavelength range may be, e.g., in the visible or near IR regions, typically between 400 nm and 1100 nm. Useful representative wavelength ranges include 500 to 550nm, 1000 to 1100 nm, 400 to 420 nm, and 700 to 850 nm, and in particular embodiments may more preferably be from about 400 nm to about 550 nm, preferably about 400-410 nm (e.g., just in the transparency region), maximizing the value of the two-photon material absorption coefficient to facilitate a two-photon absorption process. The pulsewidths may be, e.g., from about 10 fs to about 500 fs, and in more particular embodiments from about 10 fs to about 300 fs, or from about 10 to about 100 fs. The individual pulse energies may be, e.g., in the range 1 mJ to 1 J, and the beam cross-sectional equivalent circular diameters could be in the range of, e.g., 1-10 mm, and in particular embodiments 5-10 mm. In a particular representative embodiment, e.g., laser source 110 may provide 400 nm laser pulses at a frequency of 10 Hz and power of 1 J per pulse.

The laser beam 120 may have an intensity pattern imposed thereon in order to write a desired refractive index profile pattern into the optical polymeric material sample. Such an intensity pattern may be provided, e.g., by cross-sectional beam modulator 130 such as an SLM. This device could however be a liquid cooled, reflective SLM, or an optically addressed transmissive or reflective-type SLM, which would allow high powers to be sent through it after an initial modulation pattern is written on it by another laser with a patterned intensity (this technology has been developed extensively for use with extremely large lasers, where it may be called a “light valve”). In more specific embodiments, a liquid (LC) transmission modulator, or a LCOS (liquid crystal on silicon) modulator may be used. Pixel sizes resulting from a particular beam modulator typically can further be magnified/demagnified as required before focusing into the sample to get any effective exposure pixel size desired.

In order to transfer the intensity map produced by a cross-sectional beam modulator directly onto an optical polymeric material (e.g., contact lens 150), a relay system 140 may be employed. The relay system may provide sufficient depth of focus to enable writing throughout the depth of the optical polymeric material element, particularly if curved as shown.

The feasibility of the described method can be shown by referring to “Femtosecond micro-machining of hydrogels: parametric study and photochemical model including material saturation,” Ruiting Huang and Wayne H. Knox, Optical Materials Express, Vol. 9, No. 9/1 Sep. 2019, wherein very high speed laser induced refractive index writing was demonstrated for up to and including the single pulse writing limit by scanning at very high speeds using a rotational scanner, writing at an equivalent linear speed of 11.72 m/sec using a laser with 190 fs pulses at 405 nm and 8.3 MHz repetition rate at an average power of 240 mW with NA 0.3. FIG. 2 shows a magnified image of the pattern that was written in a Contamac 58 hydrogel sample at equivalent 11.72 m/sec linear scan speed, showing individual refractive index spots 201 that were written with a 1.4 micron spacing, which is close to the spot size that was written, and approximately 10 micron spacing between adjacent scan paths. This is a demonstration that single-pulse laser induced refractive index writing is possible, and also shows that no pulse accumulation is required in order to effect significant changes in the material.

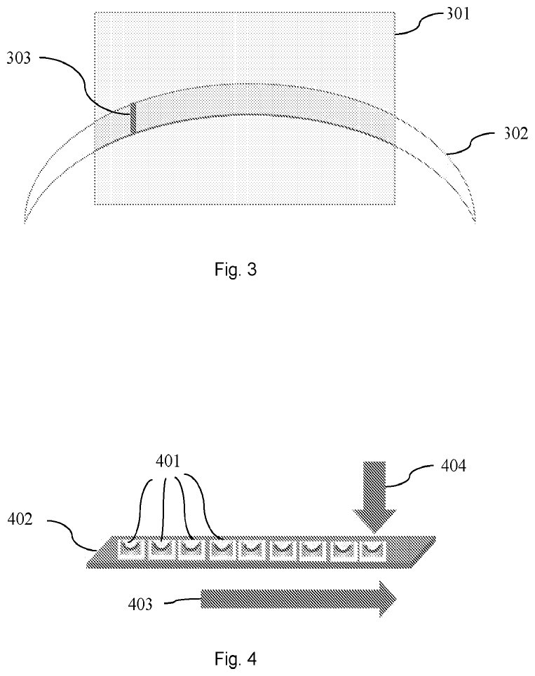

To illustrate what happens when a single pulse is incident on an optical polymeric material in the transparency region, FIG. 3 shows an unfocused large area femtosecond high energy laser beam 301 impinging on a curved contact lens 302 at normal incidence. We can consider than the incident intensity is comparable to the focused intensities in previous methodologies employing a tightly focused scanned focal spot. Multi-photon induced changes in the optical polymeric material will be induced throughout the bulk of the material. The bar 303 in FIG. 3, e.g., represents a single voxel with 1.4 micron diameter (i.e., approximately corresponding to a tightly focused focal spot size as employed in previous scanned focal spot methodologies) and extending through the thickness of the contact lens.

The change in refractive index that can be effected by any one dose of actinic radiation in optical materials is limited by the damage thresholds of the materials. In some cases, the change in refractive index achievable by writing with relatively small focal spots may be too small to support 21 phase changes, which are often desired to minimize phase discontinuities in Fresnel or other types of segmented optical structures which may be desirably written into the optical materials. However, by writing a refractive index change over extended depths, or even through the entire thickness of an optical polymeric material element as enabled by the present disclosed embodiments, a refractive index pattern may be more efficiently written to effect 2π phase changes. Writing the refractive index changes over extended depths thus makes possible faster and more accurate writing of such optical structures, as well as higher and more efficient optical performance.

Using the conditions for single-pulse excitation as employed in FIG. 2, we can estimate the amount of laser pulse energy that would be required in order to write an entire device for ocular corrections, e.g., in a 5-6 mm diameter region using a single laser pulse. Summarizing the laser conditions for the high speed single pulse writing experiments, a wavelength of 405 nm, pulsewidth of 190 fs, laser rep rate of 8.3 MHz, average power of 240 mW and focusing of roughly NA 0.5 was employed. The resultant refractive index change due to a single pulse was easily visible, therefore it may be assumed that it was about one half-wave of phase shift. Single blue pulses at 240 mW average power could write laser induced refractive index changes, and at 8.3 MHz that corresponds to single pulse energies of 29 nJ per pulse, in roughly a 1.4 micron spot size. For simultaneously writing a refractive index across a two-dimensional area of a device of approximately 6 mm diameter, it would require simultaneously writing approximately 4286 ×4286 adjacent spots (i.e., 1.837 million spots) across the cross-sectional area, so the corresponding required laser single pulse energy would be approximately 0.53 Joules. Accordingly, use of a laser with about 0.5 joules of energy in a single pulse at 405 nm should provide approximately the same phase shift per each 1.4 micron exposed area across the laser cross-sectional area.

High energy femtosecond lasers of this type are currently commercially available at repetition rates up to, e.g., 10 Hz. Use of such a high energy laser in a refractive index writing system could provide, e.g., 600 custom lenses per minute, 36,000 per hour, 864,000 per 24 hour day, 26.7 million per month or 315 million per year, when employed with a transport mechanism configured for moving a series of optical polymeric material elements (such as blank contact lenses) with respect to the pulsed laser beam output at a rate of 10 elements per second (i.e., at a rate matching the frequency of the high power laser employed). One example of such a high speed delivery and positioning system transport mechanism is schematically illustrated in FIG. 4, wherein a series of optical polymeric material elements 401 (e.g., dehydrated contact lenses still in there manufacturing molds) linearly arranged on a transport mechanism 402 is configured for movement in a direction 403 generally traverse to an optical axis of the pulsed laser beam output 404. While a transport rate generally corresponding to the pulsed laser repetition rate may be desirable to employ to maximize the optical polymeric material element manufacturing rate when writing with a single laser pulse for each optical element, it is noted that the described method is not limited to a single shot exposure per optical element. Rather, scaling experiments may be further employed to determine optimum values of the individual pulse energy and the repetition rate and the total number of pulses for writing a desired pattern in an optical element. In various embodiments, e.g., in order to improve manufacturing rates, a pulsed laser beam frequency and a relative rate of movement of the series of optical polymeric material elements and the pulsed laser beam outlet may be selected to provide less than or equal to 10, less than or equal to 5, or less than or equal to 2 overlapping laser pulse exposures in exposed portions of each optical polymeric material element of the series. In a further embodiment, the series of optical polymeric material elements may be moved relative to the pulsed laser beam output at a rate sufficient to achieve non-overlapping laser pulse exposures in each of the series of optical polymeric material elements.

While absorption is not limited to the surface of the optical polymeric material element, use of bulk two photon absorption (or higher multiphoton absorption) would still naturally lead to a depletion of the excitation pulse as it progresses through the element, and therefore the resulting refractive index effects may still be largest near the entrance surface of the exposed optical element. The resulting refractive index effect may accordingly diminish with propagation through the sample, and would depend on the strength of the excitation.

The proposed system eliminates many of the costly and complicated elements of prior disclosed tightly focused focal spot scanning-based systems, particularly for use in contact lens (and other optical polymeric material devices) manufacturing, where there are no eye exposure limitations prohibiting use of high energy lasers.

One of the advantages of using an unfocused femtosecond laser beam (or even a relatively only weakly focused beam focused with a numerical aperture NA=0.05 or less) is that it may not necessarily matter whether the substrate to be written is flat or curved. In fact, it may not even matter if the substrate such as a contact lens is positively or negatively curved. In the previous methodologies employing tightly focused scanned focal spots, on the other hand, there is a very significant difference between writing in flat or curved substrates, as the depth of a tightly focused laser spot must also be controlled when writing in a curved element. This is significant for high speed manufacturing of contact lenses, particularly of contact lenses in their as-manufactured curved configurations. The present proposed methodologies will in particularly be applicable to writing in curved contact lenses in their wet, hydrated state, as well as writing in dry hydrogel contact lenses, i.e. during a step of manufacture of the contact lens before it is hydrated.

### Scanned Focal Line Embodiment

In a further embodiment of the disclosure, rather than write a full refractive index pattern simultaneously across an entire desired two-dimensional portion of an optical polymeric material element employing a relatively high power laser, a pulsed laser beam output may be focused with a cylindrical lens function to form a pulsed laser beam focal line having a length of at least 1 mm (or at least 5 mm, or at least 6 mm, or at least 6.5 mm), the optical polymeric material may be exposed to the pulsed laser beam output simultaneously over the length of the focal line, and the pulsed laser beam focal line may be scanned across the optical polymeric material by moving at least one of the pulsed laser beam focal line and the optical polymeric material relative to the other in a direction generally traverse to a linear direction of the focal line.

Similarly as in the two-dimensional simultaneous exposure, non-scanning embodiment described above, the amount of laser pulse energy that would be required in order to write a full line of refractive index changes across a desired area of an optical polymeric material device for desired ocular corrections, e.g., in a 1-10 mm diameter region and in particular embodiments a 5-10 mm diameter region, can be estimated. Again using the conditions for single-pulse excitation as employed in FIG. 2 (i.e., a wavelength of 405 nm, pulsewidth of 190 fs, laser rep rate of 8.3 MHz, average power of 240 mW and focusing of roughly NA 0.5), an estimate of 28 nJ per pulse was obtained for writing each single pulse tightly focused (1.4 micrometer) focal spot exposure. For writing an entire 6 mm long line having a width of approximately 1.4 micrometer (i.e., approximately 4286 adjacent 1.4 micrometer spots) simultaneously with a cylindrical lens focused pulse laser beam output with similar wavelength (405 nm) and pulsewidth (190 fs), it accordingly may take about 0.12 mJ per pulse.

In the two-photon absorption refractive index writing mode, the induced phase shift scales inversely with the pulsewidth. Therefore, even lower pulse energies would be needed if using shorter pulses. In a particular embodiment, e.g., use of an available Coherent Astrella laser having the specifications of 35 fs pulsewidth at 800 nm wavelength, 7 mJ per pulse at 1 kHz repetition rate, e.g., may be employed. Use of a shorter pulsewidth means only (29 nJ)(35 fs/190 fs)=5.3 nJ/pixel would be required for each 1.4 micrometer pixel area, or only 0.023 mJ for writing a single 6 mm line at 1.4 micrometers wide. With an assumption of 35% conversion of 50% of the 7 mJ 800 nm output of the laser to SHG, this would provide 1.225 mJ energy at 400 nm and 1 kHz rep rate, sufficient for writing over 50 lines at 1 kHz rate.

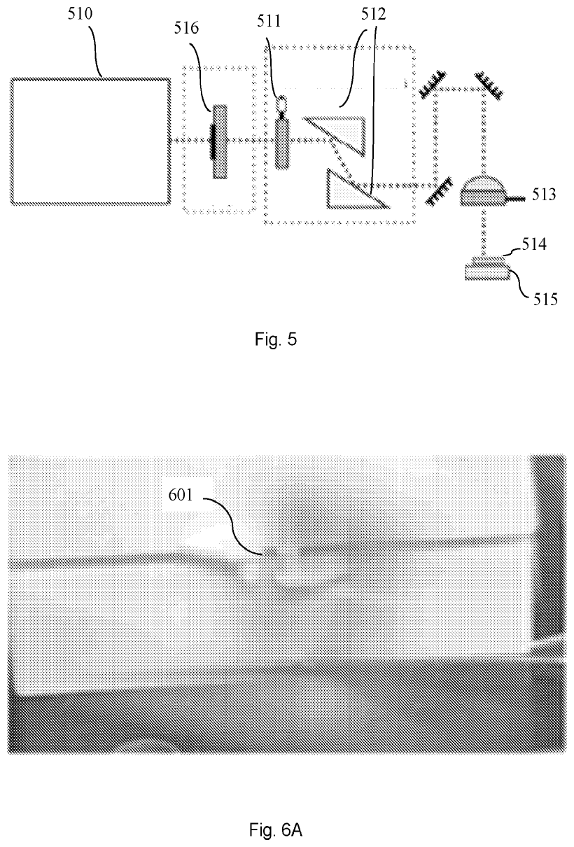

FIG. 5 shows a simplified writing configuration for one embodiment of a scanned line writing system. Pulses at 1 kHz repetition rate from a Coherent Astrella laser 510 are sent through a half-wave-plate 511 and thin film Brewster polarizer pair 512 for power control and then focused with a 100 mm cylindrical lens 513 to generate a line focus in the sample plane, having 40 fs pulsewidth and up to 2 mJ pulse energies. A 0.5 mm thick optical polymeric material sample 514 is positioned within this focal volume and translated with computerized motion stage 515 at variable speeds perpendicular to the line focus to produce a diffraction grating, which are simple demonstration devices for this technology. Sample exposure to the pulses is these experiments may be controlled using a shutter 516.

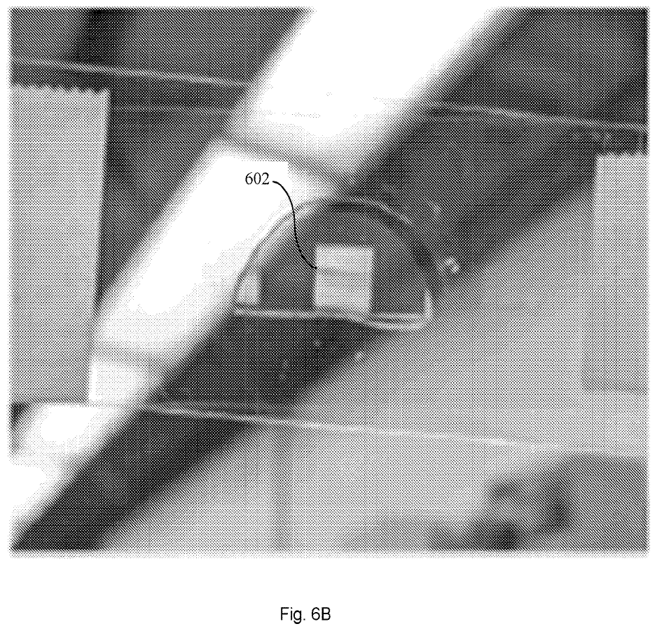

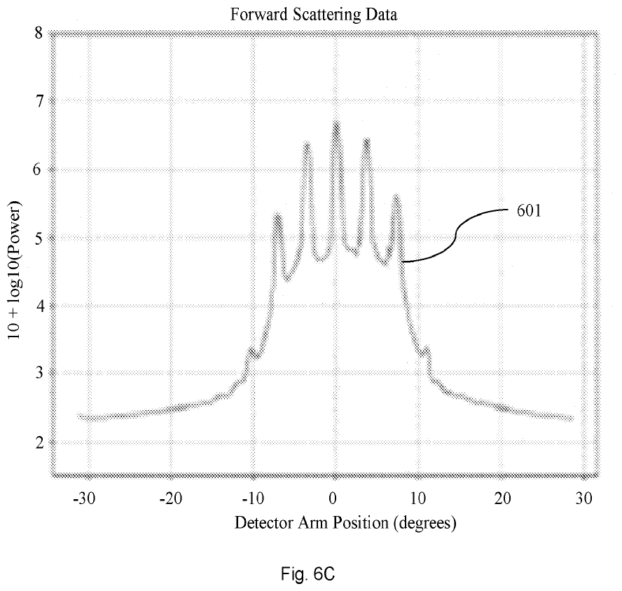

Using the system shown in FIG. 5, high quality diffraction gratings with 2.5 micron wide, 10 mm long lines were written at 1000 lines per second in a commercial HEMA-based Contamac 58 hydrogel material sample. At this speed, the diffraction grating shown in FIGS. 6A-6C was written in a single second. FIGS. 6A-6C show the diffraction pattern and scatterometer measurement showing the diffraction peaks. FIG. 6A more particularly shows a white light photo of the diffraction grating in transmission 601, while FIG. 6B shows the 1 cm×1 cm area 602 written, and FIG. 6C shows scatterometer measurements 603 of the diffraction pattern.

As shown in FIGS. 6A-6C, high quality diffraction gratings can be written at extremely high speed in the single shot regime, without material damage. Here the writing process is driven by weak 3-4 multiphoton absorption. This important, non-obvious result enables high-speed scaling of complex devices such as custom multi-focal contact lenses.

In further examples, the lines written by focusing 40 fs pulses from the Astrella (Ti:Saph Regenerative Amplifier running at 1 kHz) with a cylinder lens having relatively long focal length were demonstrated to lead to a more gradual focus than with a microscope objective and a consequently much larger focal volume, with an axial extent on the order of millimeters. Sample exposure to the pulses is these experiments was controlled using a shutter, in an off/on “black and white” manner. Rather than scanning the laser beam around, sample were translated across the line focus to be rapidly exposed to the writing beam. Experiments have further been performed with varying degrees of pulse overlap and it has been demonstrated that regions of continuous phase shift can be written without damage using this technique. More particularly, crossed lines have been written orthogonally, showing ability for total overlap of written areas without damage.

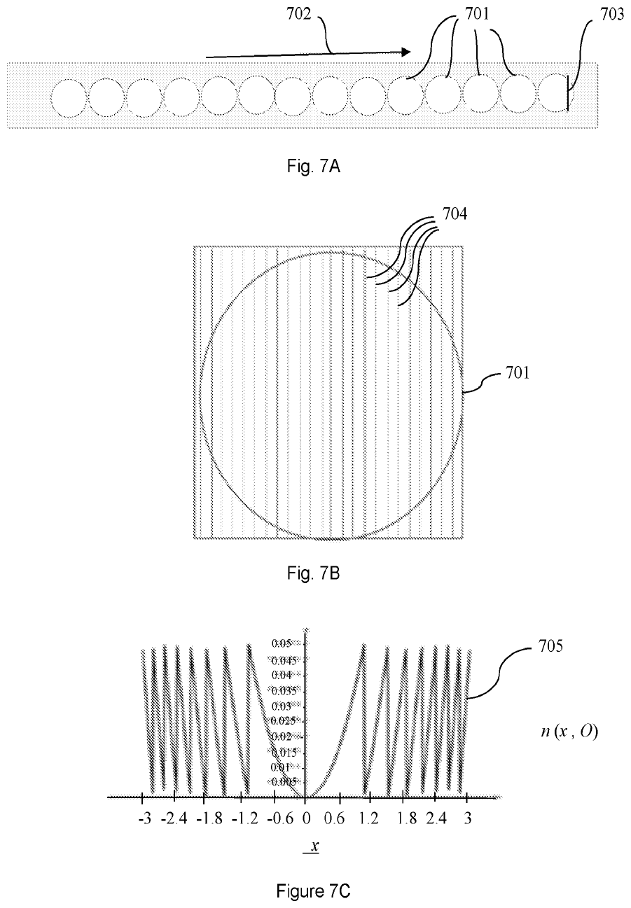

High speed writing in various embodiments may be in an assembly-line fashion. FIGS. 7A-7C show one way that it could be done. Samples 701 would be conveyed in direction 702 and passed through the 1D line focus 703 while the laser is firing, as shown in FIG. 7A. This would write a series of 1D laser induced refractive index change lines 704 into each sample 701 as shown in FIG. 7B. For 0.5 micron lines spacing at a laser frequency of 1 kHz, e.g., it would take approximately 12 seconds per lens, while for 0.5 micron lines spacing at a laser frequency of 5 kHz it would take approximately 2.4 seconds per lens. In this case, a Fresnel-lens-like intensity structure may be imposed on the cylindrically focused writing beam. An exemplary 1-D Fresnel pattern 705, e.g., is shown in FIG. 7C. Similarly as described in the 2-D modulated embodiment, this could be done with a LCOS (liquid crystal on Silicon) type of intensity modulator. For linear modulation, a deformable mirror could be used, e.g., by sending light through a filter whose transmissivity varies along one axis. By steering the beam up and down this filter, intensity modulation would be realized in the orthogonal direction. Once focused by a cylinder lens, this would become a linear variation in intensity along the line, with the effective pixel size set by the deformable mirror pixels size (typically rather large) and the magnification/demagnification of any further relaying optics. Deformable mirrors have no problem with high energy pulses and are used to steer and structure high energy laser beams in industrial cutting applications.

In various embodiments, the intensity of the pulsed laser beam focal line over the length of the focal line may accordingly be simultaneously modulated to obtain a modulated energy profile within the optical polymeric material including at least some energy profile portions above a nonlinear absorption threshold of the optical material and all of the modulated energy profile below a breakdown threshold of the optical polymeric material at which significant light scattering or absorption degrades the intended performance of the optical polymeric material, in order to obtain a desired modulated change in refractive index in the simultaneously exposed portion of the optical polymeric material.

In further embodiments, a pulsed laser beam frequency and a focal line width may be selected, and the pulsed laser beam focal line and the optical polymeric material relative may be moved relative to each other at a selected rate sufficient to provide less than or equal to 10, less than or equal to 5, or less than or equal to 2 overlapping focal line laser pulse exposures in area of the optical polymeric material. In a more particular embodiment, the pulsed laser beam focal line and the optical polymeric material are moved relative to each other at a rate sufficient to achieve non-overlapping focal line laser pulse exposures in areas of the optical polymeric material.

In various embodiments, the pulsed laser beam focal line more particularly has a length of from about 1 to about 10 mm (or of from about 5 to about 10 mm) and a width of from about 0.5-10 microns (or of from about 0.5-5 microns).

Contact lenses may typically be molded into a spherical shape in order to fit on the eye. In certain embodiments, the assembly-line style of sample processing shown in FIG. 7A may be used with curved contact lens elements as well as flat or applanated contact lens substrates. This may be, e.g., where the cylindrical lens or a relay lens system employed therewith may provide sufficient depth of focus to enable writing throughout the depth of the optical polymeric material element.

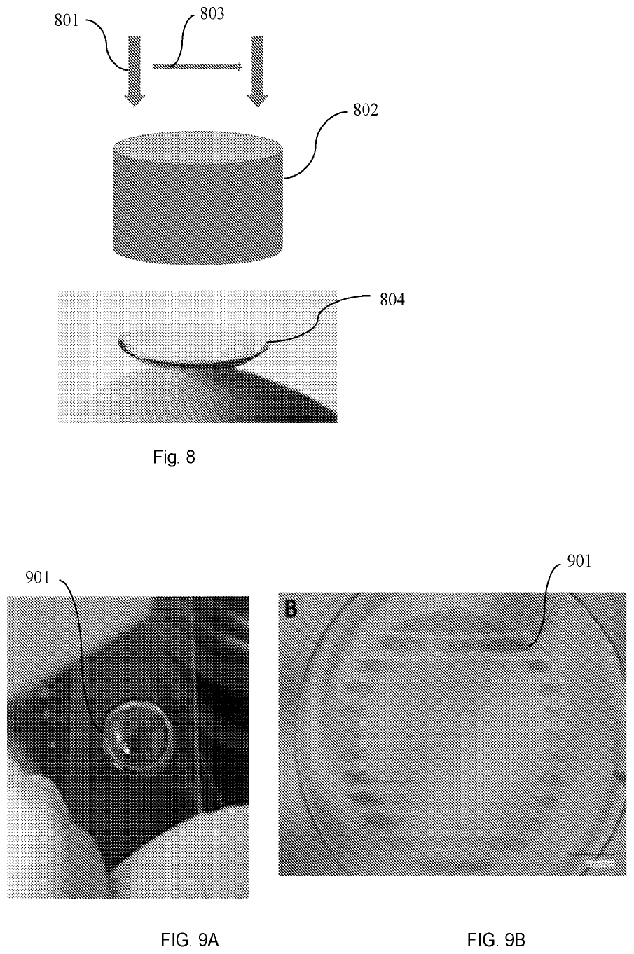

In other contemplated embodiments, where the 1D writing system must be able to write on a curved plane and remain focused at a varying depth along a focal line across the surface of a curved contact lens while the 1D line scan is written, a writing lens with a Petzval curvature matching the contact lens curvature may be used to create a curved focal plane. FIG. 8 shows such a configuration, wherein the 1D line focus 801 may be imaged into the entrance pupil of the Petzval lens 802. The 1D line scan with a Fresnel-like intensity pattern, e.g., may then be scanned across the aperture of the Petzval lens along direction 803 while the contact lens 804 is held fixed. In such an embodiment, a series of contact lens elements may be intermittently advanced to the pulsed laser output writing system employing such curved line writing lens after each line scan across a desired lens area is completed on the previous contact lens in the series.

To demonstrate refractive index writing on a curved contact lens, an Acuvue2 HEMA based optical polymeric material contact lens was modified with a high fluence writing technique employing the Coherent Astrella laser system similarly as described above (35 fs pulsewidth at 800 nm wavelength, 1 kHz repetition rate), but with 1000 mW laser light focused by an f=100 mm cylinder lens. The lens was translated as-is, by simply placing the lens face up on a microscope slide, with no flattening, cover slip, or careful positioning. Using an optical shutter, the laser was switched on and off as the sample was translated horizontally at a slightly slower speed, to produce sets of partially overlapping lines which will then form quasi-continuous phase bars. This example demonstrated the ease of processing possible with this technique. The phase bars are a demonstration of potential structures that could be written at high speed using the disclosed techniques. The results are shown in FIGS. 9A-9B, with FIG. 9A showing the written pattern in lens 901 directly after writing, and FIG. 9B showing the results in lens 901 under 20× DIC imaging with a Keyence microscope while placed in a petri dish with saline solution. 1000 mW was sufficient power to cause damage in this sample but only near the focus, which was positioned at a height corresponding to the edges of the curved lens surface. The center of the lens, a couple millimeters higher, did not experience as tight of focusing. Seen in the center of the image are clean regions of alteration (excess coloration in FIG. 9B is a result of stress birefringence in the plastic petri dish as this microscope images in reflection). Despite the curvature of the sample, these clean regions have a very large spatial extent of approximately 6 mm across the sample at the center. The bulk damage seen on the edges of the sample has a sharp and consistent relationship with height on the sample due to the lens'curvature and consequently a consistent relationship with focused intensity.

A control unit may be operatively coupled with each of the laser beam source, a laser beam cross-sectional intensity modulator, a laser beam pulse control assembly, and a scanning/interface assembly. The control unit may provide coordinated control of each component of the laser beam writing system so that each pulse exposure has a selected intensity modulation over a relatively large area of the optical polymeric material being modified. In particular, the system components are adjustable for maintaining an energy profile within the optical material along a simultaneously exposed region above a nonlinear absorption threshold of the optical material and below a breakdown threshold of the optical material at which significant light scattering or absorption degrades the intended performance of the optical material.

The control unit can have any suitable configuration. For example, in some embodiments, the control unit comprises one or more processors and a tangible memory device storing instructions executable by the one or more processors to cause the control unit to control and coordinate operation of the laser beam source, the laser beam cross-sectional modulator, the laser beam pulse control assembly, and the scanning/interface assembly to produce a desired refractive index pattern in an exposed region of the optical polymeric material.

Further details of useful laser induced refractive index change writing system are described in US Patent Application Publication No. 20160144580 A1, U.S. Pat. Nos. 7,789,910 B2, 8,337,553 B2, 8,486,055 B2, 8,512,320 B1, and 8,617,147 B2. All of the above named patents, including the '910, '553, '055, '320, and '147 patents are incorporated herein by reference in their entirety for all purposes.

In exemplary embodiments, the optical polymeric materials more particularly may include ophthalmic hydrogel polymers, such as those typically used in contact lenses and intraocular lenses.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for writing a desired phase change pattern in an optical polymeric material, comprising:
generating at least one pulsed laser beam output from a pulsed laser source, where the pulsed laser beam output has a laser beam cross sectional area with at least one cross sectional linear dimension of at least 1 mm;
exposing the optical polymeric material to the pulsed laser beam output simultaneously over at least a portion of the optical polymeric material having at least one linear dimension of at least 1 mm; and
controlling an intensity of the simultaneous exposure of the pulsed laser beam output over the at least a portion of the optical polymeric material to obtain an energy profile within the optical polymeric material above a nonlinear absorption threshold of the optical material and below a breakdown threshold of the optical polymeric material, and to obtain a desired change in refractive index in the at least a portion of the optical polymeric material.

2. The method of claim 1, wherein the pulsed laser beam output has a laser beam cross sectional area with at least one cross sectional linear dimension of at least 5 mm, and wherein the optical polymeric material is exposed to the pulsed laser beam output simultaneously over at least a portion of the optical polymeric material having at least one linear dimension of at least 5 mm.

3. The method of claim 1, further comprising differentially modulating the intensity of the simultaneous exposure of the pulsed laser beam output over the at least a portion of the optical polymeric material to obtain a modulated energy profile within the optical polymeric material including at least some energy profile portions above a nonlinear absorption threshold of the optical material and all of the energy profile below a breakdown threshold of the optical polymeric material at which significant light scattering or absorption degrades the intended performance of the optical polymeric material, and obtaining a desired modulated change in refractive index in the simultaneously exposed portion of the optical polymeric material.

4. The method of claim 1, further comprising
focusing the pulsed laser beam output with a cylindrical lens function to form a pulsed laser beam focal line having a length of at least 1 mm,
exposing the optical polymeric material to the pulsed laser beam output simultaneously over the length of the focal line, and
scanning the pulsed laser beam focal line across the optical polymeric material by moving at least one of the pulsed laser beam focal line and the optical polymeric material relative to the other in a direction generally traverse to a linear direction of the focal line.

5. The method of claim 4, wherein the pulsed laser beam output is focused with the cylindrical lens function to form a pulsed laser beam focal line having a length of at least 5 mm.

6. The method of claim 4 or 5, further comprising simultaneously differentially linearly modulating the intensity of the pulsed laser beam focal line over the length of the focal line to obtain a modulated energy profile within the optical polymeric material including at least some energy profile portions above a nonlinear absorption threshold of the optical material and all of the modulated energy profile below a breakdown threshold of the optical polymeric material at which significant light scattering or absorption degrades the intended performance of the optical polymeric material, and obtaining a desired modulated change in refractive index in the simultaneously exposed portion of the optical polymeric material.

7. The method of claim 6, wherein a pulsed laser beam frequency and a focal line width are selected, and further comprising moving the pulsed laser beam focal line and the optical polymeric material relative to each other at a selected rate sufficient to provide less than or equal to 10, less than or equal to 5, or less than or equal to 2 overlapping focal line laser pulse exposures in areas of the optical polymeric material.

8. The method of claim 6, wherein the pulsed laser beam focal line and the optical polymeric material are moved relative to each other at a rate sufficient to achieve non-overlapping focal line laser pulse exposures in areas of the optical polymeric material.

9. The method of claim 3, wherein the pulsed laser beam focal line has a length of up to 10 mm, and optionally of from 5-10 mm, and a width of from 0.5-10 micrometers.

10. The method of claim 1, wherein the pulsed laser beam output has a laser beam cross sectional area with at least two perpendicular cross sectional linear dimensions of at least 1 mm, and further comprising exposing the optical polymeric material to the pulsed laser beam output simultaneously over at least a portion of the optical polymeric material having at least two perpendicular linear dimensions of at least 1 mm each.

11. The method of claim 1, wherein the pulsed laser beam output has a laser beam cross sectional area with at least two perpendicular cross sectional linear dimensions of at least 5 mm, and further comprising exposing the optical polymeric material to the pulsed laser beam output simultaneously over at least a portion of the optical polymeric material having at least two perpendicular linear dimensions of at least 5 mm each.

12. The method of claim 10, further comprising simultaneously differentially modulating the intensity of the pulsed laser beam output over the exposed portion of the optical polymeric material to obtain a modulated energy profile within the optical polymeric material including at least some energy profile portions above a nonlinear absorption threshold of the optical material and all of the modulated energy profile below a breakdown threshold of the optical polymeric material at which significant light scattering or absorption degrades the intended performance of the optical polymeric material, and obtaining a desired modulated change in refractive index in the simultaneously exposed portion of the optical polymeric material.

13. The method of claim 10, further comprising exposing a series of optical polymeric material elements to the pulsed laser beam output to write a desired phase change pattern in each of optical polymeric material elements of the series, by moving at least one of the pulsed laser beam output and the series of optical polymeric material elements relative to the other in a direction generally traverse to an optical axis of the pulsed laser beam output.

14. The method of claim 13, wherein a pulsed laser beam frequency and a relative rate of movement of the series of optical polymeric material elements and the pulsed laser beam outlet are selected to provide less than or equal to 10, less than or equal to 5, or less than or equal to 2 overlapping laser pulse exposures in exposed portions of each optical polymeric material element of the series.

15. The method of claim 13, wherein the series of optical polymeric material elements are moved relative to the pulsed laser beam output at a rate sufficient to achieve non-overlapping laser pulse exposures in each of the series of optical polymeric material elements.

16. A method of claim 13, wherein the pulsed laser beam output and exposed portion of each optical polymeric material element in the series has a cross-sectional area of at least 10 mm² (e.g., from 10-100 mm²).

17. (canceled)

18. The method of claim 1, wherein the optical polymeric material includes a photosensitizer for enhancing the efficiency of nonlinear multiphoton absorption.

19. (canceled)

20. (canceled)

21. The method of claim 1, in which the laser exposed regions of the optical polymeric material having a change in refractive index have a thickness capable of supporting a 2π phase change for a nominal wavelength intended for propagation through the optical material.

22. The method of claim 1, wherein the optical polymeric material is exposed to the pulsed laser beam output simultaneously over at least a portion of the optical polymeric material having at least one linear dimension of at least 6 mm.

23. The method of claim 1, wherein the optical polymeric material is exposed to the pulsed laser beam output simultaneously over at least a portion of the optical polymeric material having at least one linear dimension of at least 6.5 mm.

24. (canceled)

25. (canceled)
